(19) United States
(12) Patent Application Publication
(10) Pub. No.: US 2008/0150928 A1
(43) Pub. Date: Jun. 26, 2008

(54) Display Unit

(75) Inventors: Siebe Jan Van Der Hoef, Eindhoven (NL); Hjalmar Edzer Ayco Huitema, Eindhoven (NL); Leon Wilhelmus Godefridus Stofmeel, Eindhoven (NL); Leendert Marinus Hage, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,986

(22) PCT Filed: Feb. 15, 2005
(86) PCT No.: PCT/IB2005/050578

§ 371 Date: Aug. 15, 2006

(30) Foreign Application Priority Data
Feb. 19, 2004 (EP) 04100662.8

(51) Int. Cl. G09G 3/34

(52) U.S. Cl. 345/210

(57) ABSTRACT

Display units (1) comprising pixels arranged in rows and columns coupled via transistors (12) to row (41, 45, 49) and column (31, 32, 39) electrodes show a relatively large gradient in the image. By introducing means (30, 40) for reducing a voltage difference resulting from a voltage jump on a predefined line, which voltage jump arrives via a capacitance (13, 14), this gradient is reduced. The capacitance (13, 14) may comprise a storage capacitor (13), with the predefined line being a storage line (25). The capacitance (13, 14) may also comprise a parasitic capacitor (14) of the transistor (12), with the predefined line corresponding with the row electrode (41, 45, 49) in the same row. The means (30, 40) comprise line driving circuitry (40) and data driving circuitry (30) for supplying a data signal to pixels (11). The means (30, 40) may also comprise line driving circuitry (40) for driving at a reduced amplitude and may comprise storage line driving circuitry for driving the storage line (25).

The invention relates to a display unit, to a display device comprising a display unit, to a method for driving a display unit and to a processor program product for driving a display unit.

Examples of display devices of this type are: monitors, laptop computers, personal digital assistants (PDAs), mobile telephones and electronic books, electronic newspapers, and electronic magazines.

A prior art display unit is known from Unites States Patent US 2002/0005832 A1. This patent application discloses an electrophoretic display comprising pixels arranged in rows and columns. Each pixel is coupled to a common electrode or counter electrode and is coupled via a pixel electrode to the drain of a transistor, of which the source is coupled to a column electrode or data electrode and of which the gate is coupled to a row electrode or selection electrode. This arrangement of pixels, transistors and row and column electrodes jointly forms an active matrix. A row driver (select driver) supplies a row driving signal or a selection signal for selecting a row of pixels and the column driver (data driver) supplies column driving signals or data signals to the selected row of pixels via the column electrodes and the transistors.

Each pixel for example corresponds with a microcapsule comprising charged particles. In dependence of a positive or negative voltage applied to the pixel electrode, the particles move, and the pixel becomes white/colored or appears dark to a viewer. When the electric voltage is removed, the display unit remains in the acquired state and exhibits a bi-stable character.

The time-interval required for driving all pixels in all rows once (by driving each row one after the other and by driving all columns simultaneously once per row) is called a frame. Per frame, each data signal for driving a pixel requires, per row, a row driving action for supplying the row driving signal (the selection signal) to the row for selecting (driving) this row, and a column driving action for supplying the data signal, like for example a data pulse, to the pixel. The latter is done for all pixels in a row simultaneously.

During an image update time-interval for example comprising twenty frames, an image is updated. During subsequent frames, the data signals are supplied, with a data signal having a duration of zero, one, two to for example fifteen frame periods. Thereby, a data signal having a duration of zero frame periods, for example, corresponds with the pixel displaying full black assuming that the pixel already displayed full black. In case the pixel displayed a certain gray value, this gray value remains unchanged when the pixel is driven with a data signal having a duration of zero frame periods, in other words when being driven with a data pulse having a zero amplitude. A data signal having, for example, a duration of fifteen frame periods comprises fifteen data pulses and results in the pixel displaying full white, and a data signal having a duration of one to fourteen frame periods, for example, comprises one to fourteen data pulses and results in the pixel displaying one of a limited number of gray values between full black and full white.

As disclosed in paragraphs 0009-0013 of US 2002/0005832 A1, before and after the supply of a voltage differential corresponding with a desired image update, in other words before and after the supply of the data pulses, a uniform voltage can be supplied, to cancel an electrostatic field and to fix the particles. Such a uniform voltage initialises the particle positions.

The known display unit is disadvantageous, inter alia, due to still comprising a relatively large gradient in the image. Such a gradient results from voltage differences present across the pixels, which voltage differences are present across the pixels in each row before the row is driven and which voltage differences are overruled by driving the row. Because of a first row for example being driven firstly in a frame and a last row for example being driven lastly in the frame, the gradient exists.

It is an object of the invention, inter alia, to provide a display unit, in which the gradient in the image is reduced.

Further objects of the invention are, inter alia, providing a display device comprising a display unit in which the gradient in the image is reduced, and providing a method for driving a display unit and a processor program product for driving a display unit, for use in (combination with) a display unit in which the gradient in the image is reduced.

A display unit according to the invention comprises:
a display panel with a bi-stable pixel coupled to a predefined line via a capacitance; and
means for reducing a voltage difference across the pixel resulting from a voltage-jump on the predefined line.

Via the capacitance including an intentionally induced capacitance and/or a parasitic capacitance, the voltage jump on the predefined line is passed to the pixel. This results in the voltage difference across the pixel, which voltage difference is responsible for a relatively large gradient. By introducing means for reducing this voltage difference, this gradient is reduced.

It should be noted that US 2002/0005832 A1 discloses the supply of a uniform voltage to a pixel, to cancel an electrostatic field present before this uniform voltage is supplied. The supply of such a uniform voltage does not prevent the development of voltage differences as a result of voltage jumps which are passed via capacitances to the pixels after the uniform voltage has been supplied. Further, US 2002/0005832 A1 discloses the supply of a break voltage to a pixel to stop the movement of the particles rapidly. Such a break voltage must roughly correspond with the reverse of the voltage difference present across the pixel before this break voltage is supplied. Therefore, the break voltage does not reduce the gradient either.

An embodiment of a display unit according to the invention is defined by the pixel being coupled via a switching element to a line neighbouring the predefined line, with the capacitance comprising a storage capacitor. In this case, a line like for example a row is coupled to the control electrodes like for example the gates of all switching elements like for example transistors in this line. The pixels in this line are coupled to first main electrodes like for example the drains of the switching elements in this line and are coupled via storage capacitors to a previous line or a next line. These storage capacitors increase the stability of the signals on the pixels. For example, at the beginning of an image update time-interval, all lines are switched from a zero voltage to a non-select voltage simultaneously. These voltage jumps are passed via the storage capacitors to the pixels and result in unwanted switching effects on the pixels in these neighbouring lines. By applying the means for reducing these unwanted switching effects on the pixels, the gradient is reduced.

An embodiment of a display unit according to the invention is defined by the means comprising line driving circuitry and data driving circuitry for supplying a data signal to pixels in at least two non-neighbouring lines simultaneously for the reducing of the voltage difference. Due to neighbouring lines being coupled to each other via the storage capacitors and the switching elements, only non-neighbouring lines can receive the data signal simultaneously. Preferably, one group of non-neighbouring lines comprises all odd rows, and one other group of non-neighbouring lines comprises all even rows. Then, only a small fraction of one frame is necessary to reduce the voltage differences. The data driving circuitry may comprise one or more digital drivers for realising a zero voltage data signal, or may comprise one or more analog drivers for realising a low voltage data signal of for example 10% or 20% of the extreme voltage value of for example plus and minus fifteen Volt. Alternatively, the one or more digital drivers may receive a switched voltage supply for realising the low voltage data signal.

An embodiment of a display unit according to the invention is defined by the pixel being coupled to a switching element, with the capacitance comprising a parasitic capacitor of the switching element. In this case, a line like for example a row is coupled to the control electrodes like for example the gates of all switching elements like for example transistors in this line. The pixels in this line are coupled to first main electrodes like for example the drains of the switching elements in this line. For example, at the beginning of an image update time-interval, all lines are switched from a zero voltage to a non-select voltage simultaneously. These voltage jumps are passed via the parasitic capacitors to the pixels and result in voltage differences across the pixels. These voltage differences are also known as kickback voltages. By applying the means for reducing these voltage differences, the gradient is reduced.

An embodiment of a display unit according to the invention is defined by the means comprising line driving circuitry and data driving circuitry for supplying a data signal to pixels in at least two lines simultaneously for the reducing of the voltage difference. In this case, all lines can receive the data signal simultaneously and only a small fraction of one frame is necessary to reduce the kickback voltages. Again, the data driving circuitry may comprise one or more digital drivers for realising a zero voltage data signal, or may comprise one or more analog drivers for realising a low voltage data signal of for example 10% or 20% of the extreme voltage value of for example plus and minus fifteen Volt. Alternatively, the one or more digital drivers may receive a switched voltage supply for realising the low voltage data signal.

An embodiment of a display unit according to the invention is defined by the means comprising line driving circuitry for driving at least two lines simultaneously at a reduced amplitude for the reducing of the voltage difference. In this case, the kickback voltages are reduced because of the reduced line driving voltages. This is possible as long as the data signals originating from the data driving circuitry have relatively small amplitudes.

The line driving circuitry may comprise one or more analog drivers for realising a lower voltage selection signal of for example 60% or 70% of the extreme voltage value of for example plus and minus twenty-five Volt. Alternatively, one or more digital line drivers may receive a switched voltage supply for realising the lower voltage selection signal.

An embodiment of a display unit according to the invention is defined by the predefined line being a storage line coupled via storage capacitors to pixels, with the means comprising storage line driving circuitry for driving the storage line for the reducing of the voltage difference. In this case, per line of pixels there is a storage line, with each pixel in the line of pixels being coupled via a storage capacitor to this storage line. The storage line driving circuitry drives the storage line with a voltage signal, which is passed to the pixels via the storage capacitors to reduce the kickback voltage present across the pixel. This storage line driving circuitry may be realised by (an extension of) the data driving circuitry comprising one or more analog drivers for realising a low voltage storage line signal of for example 10% or 20% of the extreme voltage value of the data signal of for example plus and minus fifteen Volt or comprising one or more digital drivers receiving a switched voltage supply for realising the low voltage storage line signal. Alternatively, the storage line driving circuitry may be circuitry separated from the data driving circuitry.

An embodiment of a display unit according to the invention is defined by the voltage difference being reduced at the start and/or the end of an image update time-interval. For example, at the end of an image update time-interval, all lines are switched from a non-select voltage to a zero voltage simultaneously. These voltage jumps at the end of the image update time-interval are, just like the voltage jumps at the beginning of the image update time-interval, passed via the parasitic capacitors to the pixels and result in voltage differences across the pixels.

An embodiment of a display unit according to the invention is defined by further comprising a controller, which is adapted to provide shaking data pulses, one or more reset data pulses, and one or more driving data pulses to the pixels. The shaking data pulses reduce the dependency of the optical response of the electrophoretic display unit on the history of the pixels. The shaking data pulses comprise pulses representing energies which are sufficient to release the electrophoretic particles from a static state at one of the two electrodes, but which are too low to allow the electrophoretic particles to reach the other one of the electrodes. Because of the reduced dependency on the history of the pixels, the optical response to identical data will be substantially equal, regardless of the history of the pixels. The underlying mechanism can be explained by the fact that, after the display device is switched to a predetermined state, for example a black state, the electrophoretic particles come to a static state. When a subsequent switching to the white state takes place, the momentum of the particles is low because their starting speed is close to zero. This results in a high dependency on the history of the pixels resulting in a long switching time to overcome this high dependency. The application of the shaking data pulses increases the momentum of the electrophoretic particles and thus reduces the dependency resulting in a shorter switching time. The reset data pulses precede the driving data pulses to further improve the optical response of the display unit, by defining a fixed starting point (fixed black or fixed white) for the driving data pulses. Alternatively, the reset data pulses precede the driving data pulses to further improve the optical response of the display unit, by defining a flexible starting point (black or white, to be selected in dependence of and closest to the gray value to be defined by the following driving data pulses) for the driving data pulses.

The display device as claimed in claim 10 may be an electronic book, while the storage medium for storing information may be a memory stick, an integrated circuit, a memory like an optical or magnetic disc or other storage device for storing, for example, the content of a book to be displayed on the display unit.

Embodiments of a method according to the invention and of a processor program product according to the invention correspond with the embodiments of a display unit according to the invention.

The invention is based upon an insight, inter alia, that gradients in the image result from voltage differences across the pixels, whereby the voltage differences result from voltage jumps arriving via capacitances, and is based upon a basic idea, inter alia, that these voltage differences resulting from these voltage jumps are to be reduced.

The invention solves the problem, inter alia, of providing a display unit, in which the gradient in the image is reduced, and is advantageous, inter alia, in that the quality is improved at the same frame rate, and in that the same quality can be realised at a lower frame rate.

These and other aspects of the invention will be apparent from and elucidated with reference to the embodiments(s) described hereinafter.

In the drawings:

FIG. 1 shows (in cross-section) a bi-stable pixel;

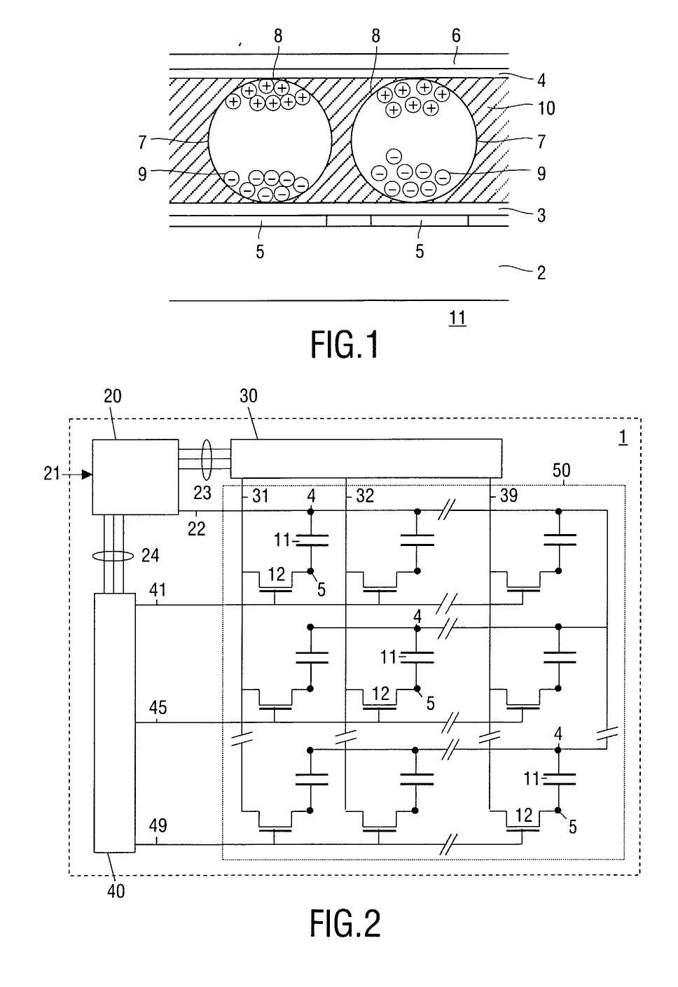

FIG. 2 shows diagrammatically a display unit;

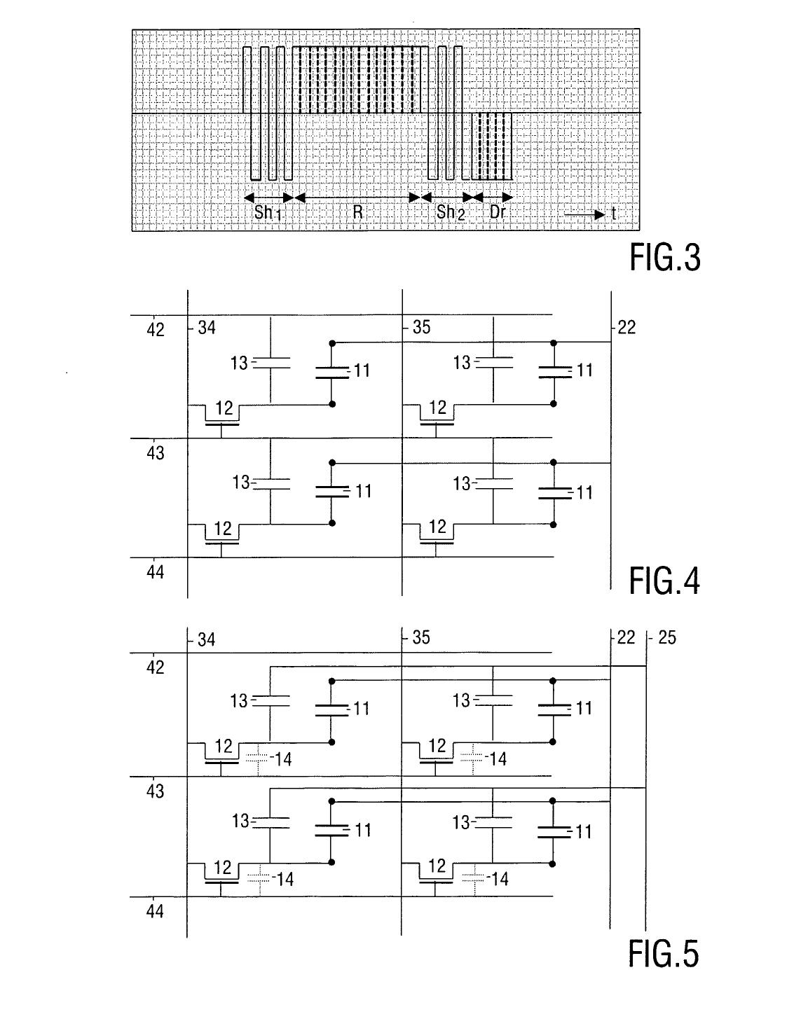

FIG. 3 shows a waveform for driving a display unit;

FIG. 4 shows diagrammatically a part of a display panel comprising storage capacitors;

FIG. 5 shows diagrammatically a part of a display panel disclosing parasitic capacitors;

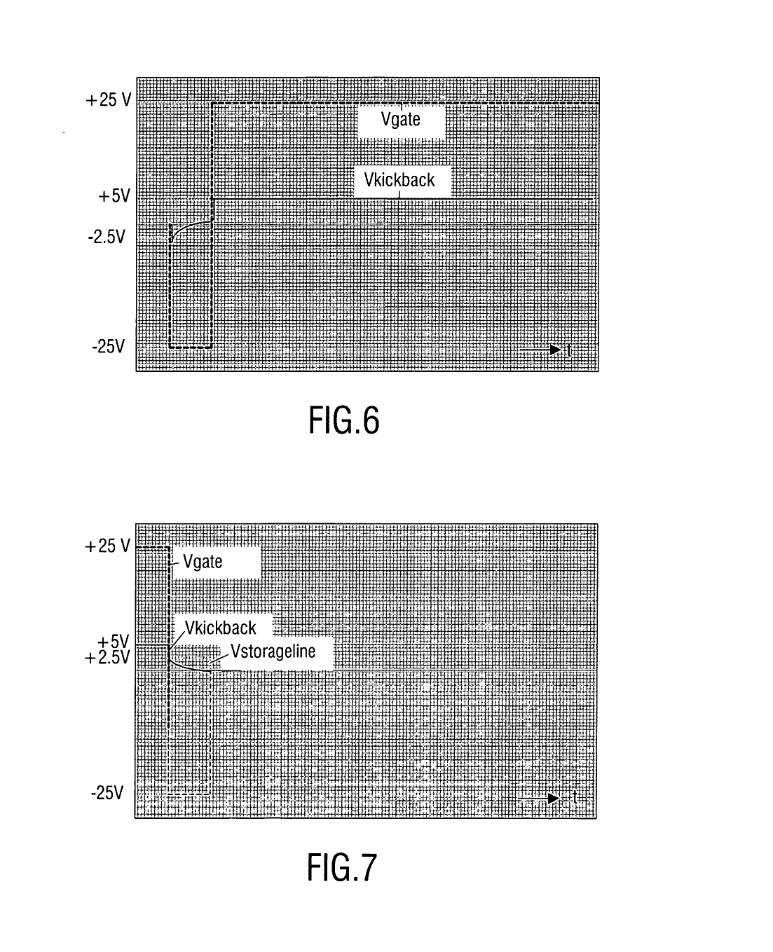

FIG. 6 shows a gate voltage and a kickback voltage at the beginning of an update time-interval; and

FIG. 7 shows a gate voltage and a kickback voltage at the end of an update time-interval.

The bi-stable pixel 11 of the display unit shown in FIG. 1 (in cross-section) comprises a bottom substrate 2 (like plastic or glass), an electrophoretic film (laminated on base substrate 2) with an electronic ink which is present between a glue layer 3 and a common electrode 4. The glue layer 3 is provided with transparent pixel electrodes 5. The electronic ink comprises multiple microcapsules 7 of about 10 to 50 microns in diameter. Each microcapsule 7 comprises positively charged white particles 8 and negatively charged black particles 9 suspended in a fluid 10. When a positive voltage is applied to the pixel electrode 5, the white particles 8 move to the side of the microcapsule 7 directed to the common electrode 4, and the pixel becomes visible to a viewer. Simultaneously, the black particles 9 move to the opposite side of the microcapsule 7 where they are hidden from the viewer. By applying a negative voltage to the pixel electrode 5, the black particles 9 move to the side of the microcapsule 7 directed to the common electrode 4, and the pixel appears dark to a viewer (not shown). When the electric voltage is removed, the particles 8,9 remain in the acquired state and the display exhibits a bi-stable character and consumes substantially no power. In alternative systems, particles may move in an in-plane direction, driven by electrodes which may be situated on the same substrate.

The (electrophoretic) display unit 1 shown in FIG. 2 comprises a display panel 50 comprising a matrix of pixels 11 at the area of crossings of line or row or selection electrodes 41,45,49 and column or data electrodes 31,32,39. These pixels 11 are all coupled to a common electrode 22, and each pixel 11 is coupled to its own pixel electrode 5. The display unit 1 further comprises selection driving circuitry 40 (line or row or selection driver) coupled to the row electrodes 41,45,49 and data driving circuitry 30 (column or data driver) coupled to the column electrodes 31,32,39 and comprises per pixel 11 an active switching element 12. The display unit 1 is driven by these active switching elements 12 (in this example (thin-film) transistors). The selection driving circuitry 40 consecutively selects the row electrodes 41,45,49, while the data driving circuitry 30 provides data signals to the column electrode 31,32,39. Preferably, a controller 20 first processes incoming data arriving via input 21 and then generates the data signals. Mutual synchronisation between the data driving circuitry 30 and the selection driving circuitry 40 takes place via drive lines 23 and 24. Selection signals from the selection driving circuitry 40 select the pixel electrodes 5 via the transistors 12 of which the drain electrodes are electrically coupled to the pixel electrodes and of which the gate electrodes are electrically coupled to the row electrodes 41,45,49 and of which the source electrodes are electrically coupled to the column electrodes 31,32,39. A data signal present at the column electrode 31,32,39 is simultaneously transferred to the pixel electrode 5 of the pixel II coupled to the drain electrode of the transistor 12. Instead of transistors, other switching elements can be used, such as diodes, MIMs, etc. The data signals and the selection signals together form (parts of) driving signals.

Incoming data, such as image information receivable via input 21 is processed by controller 20. Thereto, controller 20 detects an arrival of new image information about a new image and in response starts the processing of the image information received. This processing of image information may comprise the loading of the new image information, the comparing of previous images stored in a memory of controller 20 and the new image, the interaction with temperature sensors, the accessing of memories containing look-up tables of drive waveforms etc. Finally, controller 20 detects when this processing of the image information is ready.

Then, controller 20 generates the data signals to be supplied to data driving circuitry 30 via drive lines 23 and generates the selection signals to be supplied to selection driving circuitry 40 via drive lines 24. These data signals comprise data-independent signals which are the same for all pixels 11 and data-dependent signals which may or may not vary per pixel 11. The data-independent signals comprise shaking data pulses, with the data-dependent signals comprising one or more reset data pulses and one or more driving data pulses. These shaking data pulses comprise pulses representing energy which is sufficient to release the (electrophoretic) particles 8,9 from a static state at one of the two electrodes 5,6, but which is too low to allow the particles 8,9 to reach the other one of the electrodes 5,6. Because of the reduced dependency on the history, the optical response to identical data will be substantially equal, regardless of the history of the pixels 11. So, the shaking data pulses reduce the dependency of the optical response of the display unit on the history of the pixels 11. The reset data pulse precedes the driving data pulse to further improve the optical response, by defining a flexible starting point for the driving data pulse. This starting point may be a black or white level, to be selected in dependence on and closest to the gray value defined by the following driving data pulse. Alternatively, the reset data pulse may form part of the data-independent signals and may precede the driving data pulse to further improve the optical response of the display unit, by defining a fixed starting point for the driving data pulse. This starting point may be a fixed black or fixed white level.

In FIG. 3, a waveform representing voltages across a pixel 11 as a function of time t is shown for driving an (electrophoretic) display unit 1. This waveform is generated using the data signals supplied via the data driving circuitry 30. The waveform comprises first shaking data pulses Sh₁, followed by one or more reset data pulses R, second shaking data pulses Sh₂ and one or more driving data pulses Dr. For example sixteen different waveforms are stored in a memory, for example a look-up table memory, forming part of and/or coupled to the controller 20. In response to data received via input 21, controller 20 selects a waveform for a pixel 11, and supplies the corresponding selection signals and data signals via the corresponding driving circuitry 30,40 and via the corresponding transistors 12 to the corresponding pixels 11.

A frame period corresponds with a time-interval used for driving all pixels 11 in the display unit 1 once (by driving each row one after the other and by driving all columns simultaneously once per row). For supplying data-dependent or data-independent signals to the pixels 11 during frames, the data driving circuitry 30 is controlled in such a way by the controller 20 that all pixels 11 in a row receive these data-dependent or data-independent signals simultaneously. This is done row by row, with the controller 20 controlling the selection driving circuitry 40 in such a way that the rows are selected one after the other (all transistors 12 in the selected row are brought into a conducting state).

During a first set of frames, the first and second shaking data pulses Sh₁ and Sh₂ are supplied to the pixels 11, with each shaking data pulse having a duration of one frame period. The starting shaking data pulse for example has a positive amplitude, the next one a negative amplitude, and the next one a positive amplitude etc. Therefore, these alternating shaking data pulses do not change the gray value displayed by the pixel 11, as long as the frame period is relatively short.

During a second set of frames comprising one or more frames periods, a combination of reset data pulses R is supplied, further to be discussed below. During a third set of frames comprising one or more frames periods, a combination of driving data pulses Dr is supplied, with the combination of driving data pulses Dr either having a duration of zero frame periods and in fact being a pulse having a zero amplitude or having a duration of one, two to for example fifteen frame periods. Thereby, a driving data pulse Dr having a duration of zero frame periods for example corresponds with the pixel 11 displaying full black (in case the pixel 11 already displayed full black; in case of displaying a certain gray value, this gray value remains unchanged when being driven with a driving data pulse having a duration of zero frame periods, in other words when being driven with a data pulse having a zero amplitude). The combination of driving data pulses Dr having a duration of fifteen frame periods comprises fifteen subsequent pulses and for example corresponds with the pixel 11 displaying full white, and the combination of driving data pulses Dr having a duration of one to fourteen frame periods comprises one to fourteen subsequent data pulses and for example corresponds with the pixel 11 displaying one of a limited number of gray values between full black and full white.

The reset data pulses R precede the driving data pulses Dr to further improve the optical response of the display unit 1, by defining a fixed starting point (fixed black or fixed white) for the driving data pulses Dr. Alternatively, reset data pulses R precede the driving data pulses Dr to further improve the optical response of the display unit, by defining a flexible starting point (black or white, to be selected in dependence of and closest to the gray value to be defined by the following driving data pulses) for the driving data pulses Dr.

In FIG. 4, a part of the display panel 50 is shown diagrammatically. This part comprises four pixels 11. A first pixel 11 is coupled via a transistor 12 to a row electrode 43 and to a column electrode 34. A second pixel 11 is coupled via a transistor 12 to the row electrode 43 and to a column electrode 35. A third pixel 11 is coupled via a transistor 12 to a row electrode 44 and to the column electrode 34. A fourth pixel 11 is coupled via a transistor 12 to the row electrode 44 and to the column electrode 35. The first and second pixel 11 are each coupled via a storage capacitor 13 to a previous row electrode 42, and the third and fourth pixel II are each coupled via a storage capacitor 13 to the previous row electrode 43. The pixels 11 are further coupled to the common electrode 22.

The storage capacitors 13 improve the stability of the signals on the pixels 11. By coupling the storage capacitors to a previous row electrode (or alternatively to a next row electrode), a separate storage line is avoided. The driving of a row disturbs, via the storage capacitors 13, the signals on the pixels 11 in the next row relatively little, due to the row driving signals being relatively short. Most of the time, a row is not driven and its row electrode is at a predefined voltage.

However, at the beginning of an image update time-interval, all row electrodes are switched from a zero voltage to a non-select voltage (for example +25 Volt) simultaneously. These voltage jumps are passed via the storage capacitors 13 to the pixels and result in voltage differences across the pixels 11 attached to the storage capacitors. These voltage differences are present across the pixels 11 in each row before the row is driven and are overruled by driving the row. Because of a first row for example being driven firstly in a frame and a last row for example being driven lastly in the frame, a gradient, resulting from the voltage differences present across the pixels 11, exists.

At the end of an image update time-interval, all row electrodes are switched from a non-select voltage (for example +25 Volt) to a zero voltage simultaneously. These voltage jumps at the end of the image update time-interval are, just like the voltage jumps at the beginning of the image update time-interval, passed via the storage capacitors 13 to the pixels 11 and result in voltage differences across the pixels 11. Due to the next update time-interval usually not immediately following a previous one, in the mean time, these voltage differences result in a gradient, in this case the unwanted switching of the pixels 11.

To reduce such gradients, according to the invention, means for reducing a voltage difference across the pixel 11 resulting from a voltage-jump on the previous row are introduced. In this case, these means comprise the line driving circuitry 40 and the data driving circuitry 30 for supplying a data signal to pixels 11 in at least two non-neighbouring rows simultaneously for the reducing of the voltage difference. Due to neighbouring rows being coupled to each other via the storage capacitors 13 and the switching elements 12, only non-neighbouring rows can receive the data signal simultaneously. Preferably, one group of non-neighbouring rows comprises all odd rows, and one other group of non-neighbouring rows comprises all even rows. Then, only a small fraction of one frame is necessary to reduce the voltage differences. The data driving circuitry 30 may comprise one or more digital drivers for realising a zero voltage data signal, or may comprise one or more analog drivers for realising a low voltage data signal of for example 10% or 20% of the extreme voltage value of for example plus and minus fifteen Volt. Alternatively, the one or more digital drivers may receive a switched voltage supply for realising the low voltage data signal.

So, at the beginning of the image update time-interval, after the frame in which all row electrodes are switched from a zero voltage to a non-select voltage (for example +25 Volt) simultaneously, and, at the end of the image update time-interval, after the frame in which all row electrodes are switched from a non-select voltage (for example +25 Volt) to a zero voltage simultaneously, each time a small fraction of one frame is used for supplying a row selection pulse to all even rows and to all odd rows, for supplying a data signal to the pixels 11 in the even/odd rows which results in the voltage across the pixels 11 becoming zero Volt.

In FIG. 5, a part of the display panel 50 is shown diagrammatically. This part corresponds with the part shown in FIG. 4, apart from the fact that each storage capacitor 13 is not coupled to a previous row but is now coupled to a storage line 25. Further, in addition, four parasitic capacitors 14 are disclosed. Each parasitic capacitor 14 represents the drain gate junction capacitor of a transistor 12. The driving of a row disturbs, via the parasitic capacitors 14, the data signals on the pixels 11. This kickback voltage is compensated by a prior art technology through lifting the common electrode 22 to a DC voltage.

However, at the beginning of an image update time-interval, all row electrodes are switched from a zero voltage to a non-select voltage (for example +25 Volt) simultaneously. These voltage jumps are passed via the parasitic capacitors 14 to the pixels 11 in the same row and result in voltage differences across the pixels 11 which are not compensated for by the DC voltage on the common electrode as described before. These voltage differences are present across the pixels 11 in each row before the row is driven and are overruled by driving the row. Because of a first row for example being driven firstly in a frame and a last row for example being driven lastly in the frame, a gradient, resulting from the voltage differences present across the pixels 11, exists. These voltage differences are also known as kickback voltages.

At the end of an image update time-interval, all row electrodes are switched from a non-select voltage (for example +25 Volt) to a zero voltage simultaneously. These voltage jumps at the end of the image update time-interval are, just like the voltage jumps at the beginning of the image update time-interval, passed via the parasitic capacitors 14 to the pixels 11 in the same row and result in voltage differences across the pixels 11. Due to the next update time-interval usually not immediately following a previous one, in the mean time, these voltage differences or kickback voltages result in a gradient, in this case the unwanted switching of the pixels 11.

To reduce such gradients, according to the invention, means for reducing a voltage difference across the pixel 11 resulting from a voltage-jump on the same row are introduced. In this case, the means comprise line driving circuitry 40 and data driving circuitry 30 for supplying a data signal to pixels 11 in at least two rows simultaneously for the reducing of the voltage difference. In this case, all rows can receive the data signal simultaneously and only a small fraction of one frame is necessary to reduce the kickback voltages. Again, the data driving circuitry 30 may comprise one or more digital drivers for realising a zero voltage data signal, or may comprise one or more analog drivers for realising a low voltage data signal of for example 10% or 20% of the extreme voltage value of for example plus and minus fifteen Volt. Alternatively, the one or more digital drivers may receive a switched voltage supply for realising the low voltage data signal.

So, at the beginning of the image update time-interval, after the frame in which all row electrodes are switched from a zero voltage to a non-select voltage (for example +25 Volt) simultaneously, and, at the end of the image update time-interval, after the frame in which all row electrodes are switched from a non-select voltage (for example +25 Volt) to a zero voltage simultaneously, each time a small fraction of one frame is used for supplying a row selection pulse to all rows, for supplying a data signal to the pixels 11 in the rows which results in the voltage across the pixels 11 becoming zero Volt. Of course, in case of the storage capacitors being coupled to previous or next rows, odd and even rows again need to be treated separately.

In addition, to reduce such gradients, according to the invention, further means for reducing a voltage difference across the pixel 11 resulting from a voltage-jump on the same row are introduced. In this case, the further means comprise line driving circuitry 40 for driving at least two lines simultaneously at a reduced amplitude for the reducing of the voltage difference. In this case, the kickback voltages are reduced because of the reduced line driving voltages. This is possible as long as the data signals originating from the data driving circuitry 30 have relatively small amplitudes. The line driving circuitry 40 may comprise one or more analog drivers for realising a lower voltage selection signal of for example 60% or 70% of the extreme voltage value of for example plus and minus twenty-five Volt. Alternatively, one or more digital drivers may receive a switched voltage supply for realising the lower voltage selection signal.

So, each time a small fraction of one frame is used for supplying a row selection pulse to all rows, for supplying a data signal to the pixels 11 in the rows which results in the voltage across the pixels 11 becoming zero Volt, the row selection pulse is of a reduced amplitude (of for example −15 Volt instead of −25 Volt), which results in reduced kickback voltages.

Alternatively and/or in addition, to reduce such gradients, according to the invention, yet further means for reducing a voltage difference across the pixel 11 resulting from a voltage-jump on the same row are introduced. In this case, the yet further means comprise storage line driving circuitry for driving the storage line 25 for the reducing of the voltage difference. In this case, per row of pixels 11 there is a storage line 25, with usually all storage lines 25 being coupled to each other, and with each pixel 11 in the row of pixels 11 being coupled via a storage capacitor 13 to this storage line 25. The storage line driving circuitry drives the storage line 25 with a voltage signal, which is passed to the pixels 11 via the storage capacitors 13 to reduce the kickback voltage present across the pixel 11. This storage line driving circuitry may be realised by (an extension of) the data driving circuitry 30 comprising one or more analog drivers for realising a low voltage storage line signal of for example 10% or 20% of the extreme voltage value of the data signal of for example plus and minus fifteen Volt or comprising one or more digital drivers receiving a switched voltage supply for realising the low voltage storage line signal. Alternatively, the storage line driving circuitry may be circuitry separated from the data driving circuitry 30 and controlled by the controller 20.

So, at the beginning of the image update time-interval, during or after the frame in which all row electrodes are switched from a zero voltage to a non-select voltage (for example +25 Volt) simultaneously, and, at the end of the image update time-interval, during or after the frame in which all row electrodes are switched from a non-select voltage (for example +25 Volt) to a zero voltage simultaneously, each time the storage line 25 is driven with a storage line voltage which results in the voltage across the pixels 11 becoming zero Volt. In other words, the storage line 25 is driven in such a way that the kickback voltages across the pixels are compensated.

In FIG. 6, a gate voltage Vgate and a kickback voltage Vkickback are shown at the beginning of an update time-interval. At the start of the row selection pulse (Vgate becomes −25 Volt), the kickback voltage present across the pixel 11 becomes −2.5 Volt (Vkickback becomes −2.5 Volt). Due to the supply of a data signal of zero voltage to all pixels 11 in all rows simultaneously during the row selection pulse, this kickback voltage becomes 0 Volt during the row selection pulse (Vkickback becomes 0 Volt). After the row selection pulse, a row non-selection pulse is generated and the gate voltage becomes +25 Volt (Vgate becomes +25 Volt). Simultaneously the kickback voltage becomes +5 Volt, but this is compensated by a prior art technology through lifting the common electrode 22 to 5 Volt either.

In FIG. 7, a gate voltage Vgate and a kickback voltage Vkickback are shown at the end of an update time-interval. During the non-selection pulse, the gate voltage is +25 Volt (Vgate is +25 Volt), and the kickback voltage present across the pixel 11 is +5 Volt (Vkickback is +5 Volt). This kickback voltage is compensated by the prior art technology through lifting the common electrode 22 to 5 Volt either. Then a selection pulse is generated and the gate voltage becomes −25 Volt (Vgate becomes −25 Volt). As a result of the parasitic capacitor the pixel voltage becomes 0 Volt. Simultaneously, the lifting of the common electrode 22 is finished, and the storage line 25 is lifted to +2.5 Volt (Vstorageline becomes +2.5 Volt) and as a result the pixel voltage becomes 2.5 Volt. Due to the supply of a data signal of zero voltage to all pixels 11 in all rows simultaneously during the row selection pulse, the pixel is charged to 0 Volt during the row selection pulse (Vkickback becomes 0 Volt). Then the addressing ends by setting the gate voltage and the storage capacitor line voltage to 0 Volt. This results in two effects on the pixel voltage of −2.5V and +2.5V, respectively, that cancel each other. The resulting pixel voltage is therefore 0 Volt after the addressing.

In praxis, the storage capacitor 13 is 10-100 times larger than the capacity of the pixel 11 and the parasitic capacitor 14. The kickback voltage swing is about 2.5 Volt for a gate voltage swing of about 25 Volt, and is about 5 Volt for a gate voltage swing of about 50 Volt. This can be derived from the relationship between the parasitic capacitor 14 on the one hand and the sum of the parasitic capacitor 14 and the storage capacitor 13 and the capacity of the pixel 11 on the other hand.

Controller 20 comprises and/or is coupled to a memory (not shown) like, for example, a look-up table memory for storing information about the waveforms. The invention is not limited to electrophoretic display panels but can be used for any display panel based on bi-stable pixels.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A display unit (1) comprising:
a display panel (50) with a bi-stable pixel (11) coupled to a predefined line via a capacitance (13,14); and
means (30,40) for reducing a voltage difference across the pixel (11) resulting from a voltage-jump on the predefined line.

2. A display unit (1) as claimed in claim 1, wherein the pixel (11) is coupled via a switching element (12) to a line neighbouring the predefined line, with the capacitance (13) comprising a storage capacitor.

3. A display unit (1) as claimed in claim 2, wherein the means (30,40) comprise line driving circuitry (40) and data driving circuitry (30) for supplying a data signal to pixels (11) in at least two non-neighbouring lines simultaneously for the reducing of the voltage difference.

4. A display unit (1) as claimed in claim 1, wherein the pixel (11) is coupled to a switching element (12), with the capacitance (14) comprising a parasitic capacitor of the switching element (12).

5. A display unit (1) as claimed in claim 4, wherein the means (30,40) comprise line driving circuitry (40) and data driving circuitry (30) for supplying a data signal to pixels (11) in at least two lines simultaneously for the reducing of the voltage difference.

6. A display unit (1) as claimed in claim 4, wherein the means (30,40) comprise line driving circuitry (40) for driving at least two lines simultaneously at a reduced amplitude for the reducing of the voltage difference.

7. A display unit (1) as claimed in claim 4, wherein the predefined line is a storage line (25) coupled via storage capacitors (13) to pixels (11), with the means comprising storage line driving circuitry for driving the storage line (25) for the reducing of the voltage difference.

8. A display unit (1) as claimed in claim 1, wherein the voltage difference is reduced at the start and/or the end of an image update time-interval.

9. A display unit (1) as claimed in claim 1, further comprising a controller (20), which is adapted to provide:
shaking data pulses (Sh₁,Sh₂);
one or more reset data pulses (R); and
one or more driving data pulses (Dr);
to the pixels (11).

10. A display device comprising a display unit (1) as claimed in claim 1 and further comprising a storage medium for storing information to be displayed.

11. A method for driving a display unit (1) comprising a display panel (50) with a bi-stable pixel (11) coupled to a predefined line via a capacitance (13,14), which method comprises the step of reducing a voltage difference across the pixel (11) resulting from a voltage-jump on the predefined line.

12. A processor program product for driving a display unit (1) comprising a display panel (50) with a bi-stable pixel (11) coupled to a predefined line via a capacitance (13,14), which processor program product comprises the function of reducing a voltage difference across the pixel (11) resulting from a voltage-jump on the predefined line.
